(19) United States
(12) Patent Application Publication
(10) Pub. No.: US 2012/0261011 A1
(43) Pub. Date: Oct. 18, 2012

(54) ENERGY REDUCTION MODULE USING A DEPRESSURIZING VACUUM APPARATUS FOR VACUUM PUMP

(75) Inventor: YOUNG MAN CHO, Suwon-si (KR)

(73) Assignees: YOUNG MAN CHO, Suwon-si (KR); KWANG HO PARK, Icheon-si (KR)

(21) Appl. No.: 13/086,783

(22) Filed: Apr. 14, 2011

(51) Int. Cl. B01D 21/30

(52) U.S. Cl. 137/565.15

(57) ABSTRACT

The present invention relates to a decompression module using a gas stream and a vacuum apparatus for manufacturing a semiconductor device, in which the venturi effect due to a carrier gas stream is used to decompress an exhaust-side pressure of a vacuum pump without requiring an additional power, thereby being capable of appropriately reducing the load of the vacuum pump and the power consumption.

A decompression module according to the present invention comprises a first branch pipe connected in series to an exhaust side of a vacuum pump connected to a load-lock chamber for manufacturing a semiconductor device; a check valve installed to the first branch pipe to allow a gas stream exhausted from the vacuum pump only to the atmosphere side; a second branch pipe branched from the first branch pipe to bypass the check valve; and a vacuum generator installed to the second branch pipe, the vacuum generator receiving a carrier gas from the outside and allowing the carrier gas to flow to the atmosphere side, thereby resulting in a decompression atmosphere which allows an exhaust-side pressure of the vacuum pump to be decompressed.

### BACKGROUND OF THE INVENTION

1. Field of the Invention

The present invention relates to an apparatus for manufacturing a semiconductor device, and more particularly, to a decompression module using a gas stream and a vacuum apparatus for manufacturing a semiconductor device, in which a venturi effect due to a carrier gas stream is used to decompress an exhaust-side pressure of a vacuum pump without requiring additional power, thereby being capable of appropriately reducing the load of the vacuum pump and the power consumption.

2. Description of the Related Art

Generally, a semiconductor manufacturing process includes a pre-process and a post-process. The pre-process means a process for manufacturing semiconductor chips by depositing thin films on a wafer in various process chambers and selectively etching the deposited films in a repeated way to form a predetermined pattern. The post-process means a process of individually separating the chips manufactured in the pre-process and then coupling the individual chip to a lead frame to assemble a final product.

In a wafer process in which thin films are deposited on the wafer or the thin films deposited on the wafer are etched, the wafer in the atmosphere pressure state should be transferred through a load-lock chamber in order to transfer the wafer into a process chamber. At this time, the operation of a vacuum pump allows the load-lock chamber to be converted from the atmosphere pressure state to a vacuum pressure state.

Thereafter, if the above process is completed, a step of reverting the load-lock chamber into the atmosphere pressure state by means of nitrogen or argon gas is required in order to transfer the wafer under the atmosphere pressure state. At this time, the load-lock chamber and the vacuum pump are blocked and isolated from each other by means of a switching valve installed between the load-lock chamber and the vacuum pump, and the vacuum pump is then idled.

As described above, the load-lock chamber and the vacuum pump should be essentially included in any manufacturing line for a semiconductor device, and the time practically required for the normal operation of the vacuum pump for converting the load-lock chamber into the vacuum pressure state is conventionally nothing but at most 50%. The vacuum pump remains to be idled during almost all the remaining time.

As a result, a technique for lowering the power consumption by reducing the exhaust-side load during the idling operation of the vacuum pump has recently been developed based on the understanding as described above in which the time required for the idle operation of the vacuum pump is virtually at least 50%.

Hereupon, FIG. 1 is a reference diagram illustrating a conventional vacuum apparatus for manufacturing a semiconductor device.

As illustrated in the figure, a vacuum apparatus 10 for manufacturing a semiconductor device includes a vacuum pump 20 connected to a process chamber and a load-lock chamber and having a body 21 into which a plurality of rotors R1, R2, R3, R4 and R5 rotationally driven by means of a motor 22 are embedded; a check valve 28 connected in series to an exhaust side of the vacuum pump 20 to allow a gas stream only to the atmosphere side; and an assistant pump 30 having a relative smaller capacity connected in parallel to the check valve 28 to allow an exhaust-side pressure of the vacuum pump 20 to be decompressed.

According to the configuration as described above, after the load-lock chamber and the vacuum pump 20 are opened from each other by means of a switching valve (not shown), the assistant pump 30 does not operate when the vacuum pump 20 operates in order to allow the load-lock chamber to be converted into the vacuum pressure state.

However, if the load-lock chamber and the vacuum pump 20 are blocked and isolated from each other by means of the switching valve and then the vacuum pump 20 is idled, the assistant pump 30 operates to decompress the exhaust-side pressure of the vacuum pump 20. This operation serves to reduce the load of the vacuum pump 20. Especially, since an exhaust-side rotor R5 located at the exhaust side which is opposite to an intake 23 in the multistage vacuum pump 20 must take charge of the largest compression ratio, the exhaust-side rotor R5 accounts for the largest portion of the total power consumption. Accordingly, the operation of the assistant pump 30 serves to reduce the load exerted to the exhaust-side rotor R5, so that the total power consumption which might be spent by the vacuum pump 20 can be dramatically reduced.

However, the prior art using the assistant pump 30 as described above has various intrinsic problems owing to the assistant pump 30 used to decompress the exhaust-side pressure of the vacuum pump 20.

That is, there has been a problem in that an additional cost must be expended to additionally install the assistant pump 30.

Further, since the assistant pump 30 cannot be simply connected to a conventional exhaust pipe 25 but the assistant pump 30 must be installed through relative complex steps using an additional pipe 26, there has been a problem in view of its installation.

In addition, additional power consumption for operating the additional assistant pump 30 has been a burden even if it is relatively small as compared with the vacuum pump 20. Considering this circumstance, there is a limit to totally reduce the power consumption to a satisfactory level.

### SUMMARY OF THE INVENTION

Accordingly, the present invention is conceived to solve the aforementioned problems in the prior art. An object of the present invention is to provide a decompression module using a gas stream and a vacuum apparatus for manufacturing a semiconductor device, in which a venturi effect due to a carrier gas stream is used to decompress an exhaust-side pressure of a vacuum pump without requiring additional power, thereby being capable of reducing the load of the vacuum pump and the resultant power consumption.

According to an aspect of the present invention for achieving the objects, there is provided a decompression module using a gas stream, which comprises a first branch pipe connected in series to an exhaust side of a vacuum pump connected to a load-lock chamber for manufacturing a semiconductor device; a check valve installed to the first branch pipe to allow a gas stream exhausted from the vacuum pump only to the atmosphere side; a second branch pipe branched from the first branch pipe to bypass the check valve; and a vacuum generator installed to the second branch pipe, the vacuum generator receiving a carrier gas from the outside and allowing the carrier gas to flow to the atmosphere side, thereby resulting in a decompression atmosphere which allows an exhaust-side pressure of the vacuum pump to be decompressed.

Here, the vacuum generator may include an inflow end connected to a carrier gas supply pipe for supplying the carrier gas to receive the carrier gas therethrough; an outflow end connected to an atmosphere-side pipe of the second branch pipe to exhaust the received carrier gas therethrough, the inflow end and the outflow end being formed in a straight section; a branch end branched from an intermediate point between the inflow and outflow ends and connected to an exhaust-side pipe of the second branch pipe, the branch end forming the decompression atmosphere by the flow rate of the carrier gas flowing from the inflow end to the outflow end.

Further, the intermediate point between the inflow end and the outflow end of the vacuum generator may have a smaller internal cross sectional area than those of the inflow end and the outflow end to increase the flow rate of the carrier gas.

According to another aspect of the present invention, there is provided a vacuum apparatus for manufacturing a semiconductor device, which comprises a vacuum pump connected to a load-lock chamber for manufacturing a semiconductor device; a check valve connected in series to the vacuum pump to allow a gas stream exhausted from the vacuum pump only to the atmosphere side; and a vacuum generator connected in series to the vacuum pump and in parallel to the check valve, wherein the vacuum generator includes an inflow end connected to a carrier gas supply pipe for supplying a carrier gas from the outside to receive the carrier gas therethrough; an outflow end for exhausting the received carrier gas therethrough, the inflow end and the outflow end being formed in a straight section; a branch end branched from an intermediate point between the inflow and outflow ends and connected to an exhaust side of the vacuum pump.

Here, the intermediate point between the inflow end and the outflow end of the vacuum generator may have a smaller internal cross sectional area than those of the inflow end and the outflow end so as to increase the flow rate of the carrier gas.

### BRIEF DESCRIPTION OF THE DRAWINGS

FIG. 1 is a reference diagram illustrating a conventional vacuum apparatus for manufacturing a semiconductor device;

FIG. 2 is a use state diagram of a vacuum apparatus for manufacturing a semiconductor device to which a decompression module using a gas stream according to the present invention is applied;

FIG. 3 is a diagram illustrating the configuration of the vacuum apparatus for manufacturing a semiconductor device according to the present invention;

FIG. 4 is a perspective view of the decompression module according to the present invention;

FIG. 5 is a detailed view illustrating a vacuum generator in the decompression module according to the present invention;

FIGS. 6 and 7 are reference diagrams illustrating the operation and function of the decompression module according to the present invention; and

FIG. 8 is a graph illustrating relative decrements in power consumption of a vacuum pump when the decompression module according to the present invention is mounted.

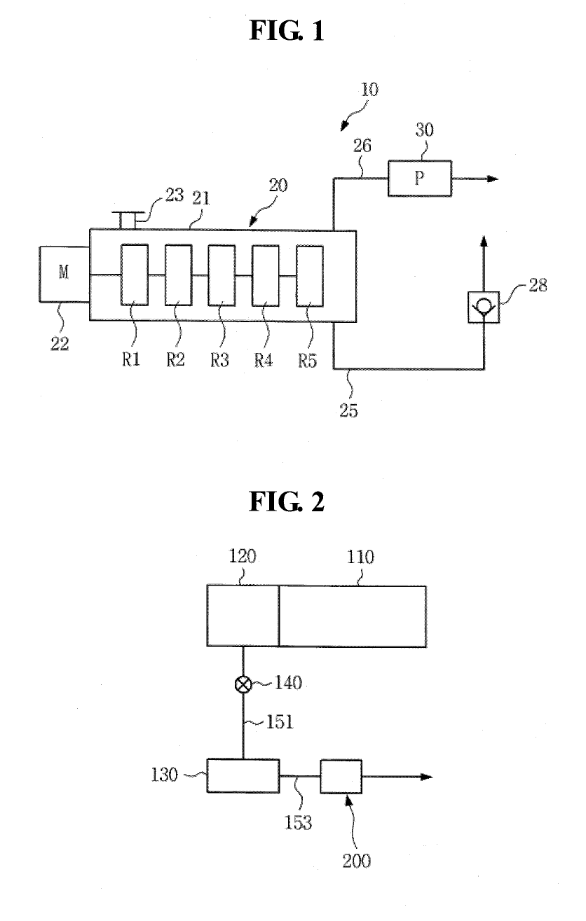

### DESCRIPTION OF THE PREFERRED EMBODIMENT

Hereinafter, preferred embodiments according to the technical spirit of the present invention will be described in detail with reference to the accompanying drawings.

FIG. 2 is a use state diagram of a vacuum apparatus for manufacturing a semiconductor device to which a decompression module using a gas stream according to the present invention is applied.

As shown in the figure, a vacuum apparatus for manufacturing a semiconductor device according to the present invention is connected to a process chamber 110 and a load-lock chamber 120, and includes a multistage vacuum pump 130 for decompressing the load-lock chamber 120, a decompression module 200 for decompressing an exhaust side of the vacuum pump 130, various pipes 151 and 153 for connecting these components to each other, and a switching valve 140. Even if the decompression module 200 is simply connected to the conventional vacuum pump 130 as described above, the vacuum apparatus for manufacturing a semiconductor device having excellent effects can be provided according to the present invention.

Here, the decompression module 200 according to the present invention may be simply installed to an exhaust pipe 153 of the vacuum pump 130 by means of flange connection. Unlike a conventional assistant pump, the exhaust-side pressure of the vacuum pump 130 can be effectively decompressed even without additional power, so that the load which might be exerted to the vacuum pump 130 can be largely reduced and the power consumption can also be largely reduced.

Hereinafter, the configuration of the vacuum apparatus for manufacturing a semiconductor device according to the present invention will be described in detail with the focus on the decompression module 200.

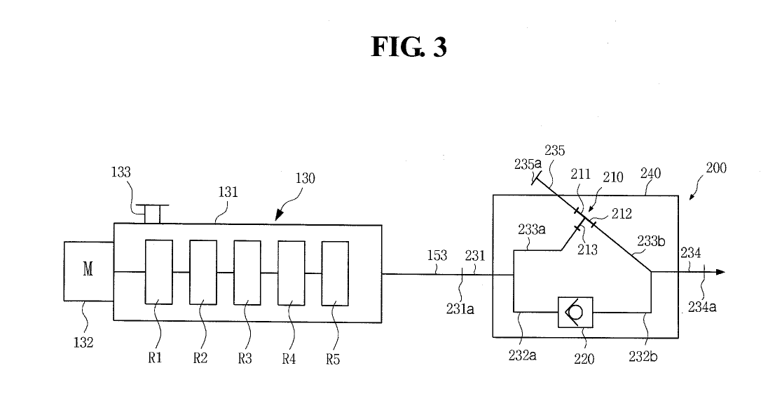

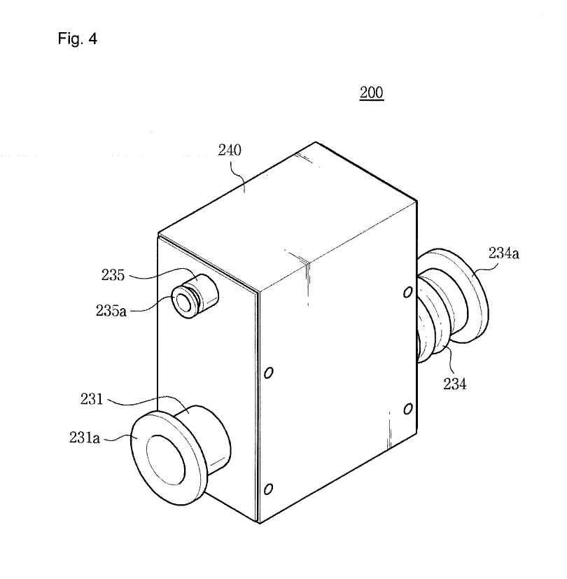

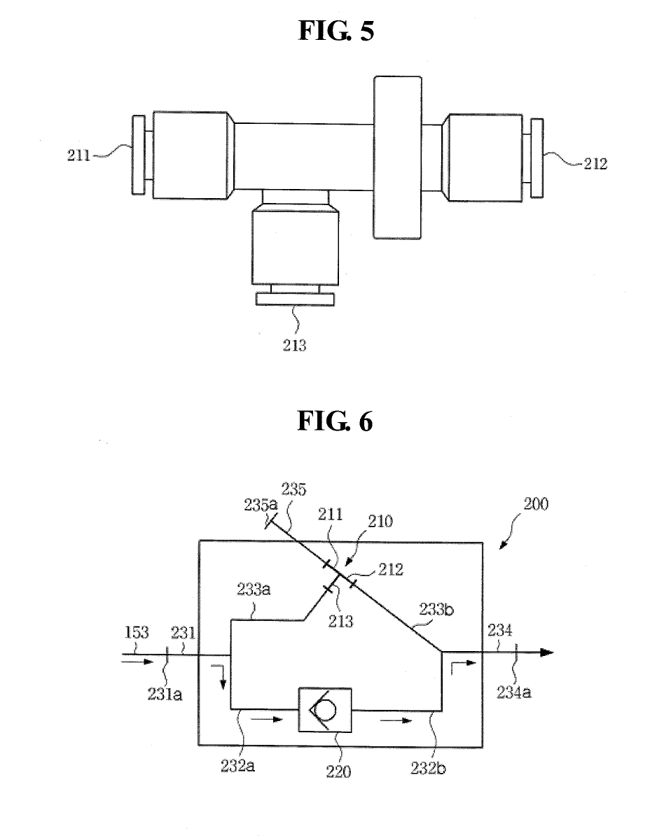

FIG. 3 is a diagram illustrating the configuration of the vacuum apparatus for manufacturing a semiconductor device according to the present invention, FIG. 4 is a perspective view of the decompression module according to the present invention, and FIG. 5 is a detailed view illustrating a vacuum generator in the decompression module according to the present invention.

As shown in the figures, the vacuum apparatus for manufacturing a semiconductor device according to the present invention generally includes the vacuum pump 130 and the decompression module 200 as its major components.

Among these components, the decompression module 200 which may be considered to constitute the technical major portion of the present invention includes a vacuum generator 210, a check valve 220 and first branch pipes 232a and 232b and second branch pipes 233a and 233b for connecting the vacuum generator 210 and the check valve 220 in parallel to each other. The decompression module 200 is configured so that the venturi action using a carrier gas stream of the vacuum generator 210 allows the exhaust-side pressure of the vacuum pump 130 to be decompressed. Hereinafter, the configuration of the present invention will be described with the focus on the respective components of the decompression module 200.

The vacuum generator 210 receives a carrier gas and allows it to flow to the atmosphere side, and the stream may result in a decompression atmosphere, which serves to allow the exhaust-side pressure of the vacuum pump 130 to be decompressed. To this end, the vacuum generator 210 is connected in series to the vacuum pump 130 by means of the second branch pipes 233a and 233b and connected in parallel to the check valve 220 installed to the first branch pipes 232a and 232b.

The vacuum generator 210 includes an inflow end 211 and an outflow end 212 which communicate with each other in a straight section, and a branch end 213 branched from an intermediate point between the inflow end 211 and the outflow end 212. The inflow end 211 of the vacuum generator 210 is connected to a carrier gas supply pipe 235, through which the carrier gas is supplied from the outside, and the outflow end 212 is connected to an atmosphere-side pipe 233b of the second branch pipes 233a and 233b. Further, the branch end 213 is connected to an exhaust-side pipe 233a of the second branch pipes 233a and 233b.

Here, the vacuum generator 210 includes a venturi tube in which the internal cross sectional area of the intermediate point between the inflow end 211 and the outflow end 212 is configured to be dramatically reduced in comparison with those of the inflow end 211 and the outflow end 212. Accordingly, when the carrier gas introduced from the inflow end 211 passes through the intermediate point at which the branch end 213 is branched, the reduced cross sectional area allows the flow rate to dramatically increase, thereby being capable of decreasing the pressure in the branch end 213 to accomplish the venturi effect. The resultant decompression atmosphere is transmitted through the exhaust-side pipe 233a of the second branch pipes 233a and 233b, which is connected to the branch end 213, and an exhaust-side combined pipe 231, so that the exhaust-side pressure of the vacuum pump 130 is reduced.

The check valve 220 is installed between the first branch pipes 232a and 232b, thereby serving to allow the gas stream exhausted from the vacuum pump 130 only to flow to the atmosphere side when the vacuum pump 130 operates. Considering the connection relationship of the check valve 220 installed between the first branch pipes 232a and 232b as described above, the check valve 220 is connected to the vacuum pump 130 in series while it is connected to the vacuum generator 210 in parallel.

After the first branch pipes 232a and 232b and the second branch pipes 233a and 233b, which are respectively installed to the check valve 220 and the vacuum generator 210, firstly start as the exhaust-side combined pipe 231 at the exhaust side and then branch off, they are recombined as an atmosphere-side combined pipe 234 at the atmosphere side. If the first branch pipes 232a and 232b and the second branch pipes 233a and 233b are combined as a single pipe at the exhaust side and the atmosphere side as described above, the decompression module 200 according to the present invention can be simply connected and installed to the middle of the exhaust pipe 153 of the vacuum pump 130 in a pipe-to-pipe connection manner using flanges 231a and 234a. Reference numeral 235a which has not been described above designates a flange installed at an end of the carrier gas inlet pipe 235, so that the flange is used to connect the carrier gas inlet pipe to a carrier gas supply pipe for transferring and supplying the carrier gas from outside.

As described above, the decompression module 200 includes the vacuum generator 210, the check valve 220, and pipes 231, 232a, 232b, 233a, 233b, 234 and 235 for connecting the vacuum generator 210 and the check valve 220. It is preferable that the decompression module 200 further includes a box-type casing 240 for receiving and encompassing these essential components. If the decompression module 200 includes the casing 240 as described above, the box-type casing 240 is primarily in sight while only the three pipes 231, 234 and 235 having their respective flanges 231a, 234a and 235a are shortly exposed to the outside of the casing 240, so that the decompression module 200 may be configured to be well arranged by appearance.

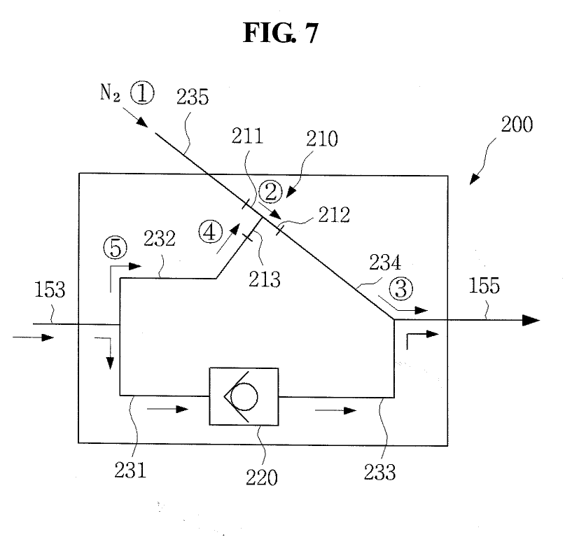

Hereinafter, the operation and function of the decompression module 200 of the present invention as constructed above will be described in detail with reference to FIGS. 6 and 7 together with the aforementioned figures.

First, FIG. 6 shows a case where the vacuum pump 130 for converting the load-lock chamber 120 into a vacuum pressure state normally operates. At this time, the switching valve 140 installed between the load-lock chamber 120 and the vacuum pump 130 is open, and then, the vacuum pump 130 is allowed to operate. The carrier gas is not supplied.

Then, the operation of the vacuum pump 130 due to the rotation of a motor 132 and the rotors R1, R2, R3, R4 and R5 allows the gas exhausted from the load-lock chamber 120 to be inhaled into a body 131 of the vacuum pump 130 through an intake 133 of the vacuum pump 130 and then to be exhausted along the exhaust pipe 153 connected to the exhaust side of the vacuum pump 130. Thereafter, the exhausted gas passes through the check valve 220 along the exhaust-side combined pipe 231 of the decompression module 200 and the exhaust-side pipe 232a of the first branch pipes 232a and 232b and is then finally exhausted to the atmosphere side along the atmosphere-side pipe 232b of the first branch pipes 232a and 232b and the atmosphere-side combined pipe 234.

As described above, when the vacuum pump 130 for maintaining the load-lock chamber 120 in a vacuum pressure state normally operates, it is necessary to exactly maintain the pressure in the load-lock chamber 120 to be a predetermined level. Accordingly, if the exhaust-side pressure of the vacuum pump 130 is lowered, the pressure in the load-lock chamber 120 is apt to be disturbed, so that damages may be brought through the process. As a result, the exhaust-side pressure is allowed not to decrease by means of the vacuum generator 210.

Meanwhile, FIG. 7 shows that the vacuum pump 130 is idled in a state where the vacuum pressure state of the load-lock chamber 120 is released. At this time, the load-lock chamber 120 and the vacuum pump 130 are blocked and isolated from each other by means of the switching valve 140 installed therebetween while the vacuum pump 130 continues to be idled.

At this time, the operation of the decompression module 200 for decompressing the exhaust-side pressure of the vacuum pump 130 proceeds. First, the carrier gas is supplied through the carrier gas inlet pipe 235 into the inflow end 211 of the vacuum generator 210. Then, the carrier gas introduced through the inflow end 211 passes through the inner side of the vacuum generator 210 and then is exhausted through the outflow end 212. Thereafter, the carrier gas passes through the atmosphere-side pipe 233b of the second branch pipes 233a and 233b and is finally exhausted through the atmosphere-side combined pipe 234.

During such a process, the flow rate of the carrier gas is dramatically increased while the carrier gas passes through the intermediate point of the vacuum generator 210 the internal cross sectional area of which is dramatically decreased. The more increased the flow rate is, the more enlarged the decompression atmosphere in the branch end 213 of the vacuum generator 210 is. The decompression atmosphere of the branch end 213, as described above, is directly transmitted through the exhaust-side pipe 233a of the second branch pipes 233a and 233b and the exhaust-side combined pipe 231 to the exhaust side of the vacuum pump 130, so that the pressure may be decompressed from the atmosphere-level pressure (i.e., 1013 mbar) to a low-level pressure which is equal to or lower than 100 mbar.

As a result, the load of the rotors R1, R2, R3 and R4 as well as the last rotor R5 which is located at the exhaust side of the vacuum pump 130 to take charge of the largest compression ratio turns to be reduced. Accordingly, the power consumption of the vacuum pump 130 is dramatically lowered. For reference, the load exerted to the rotor in the multistage vacuum pump 130 is gradually increased from its intake toward the exhaust side, so that the rotor located at the last stage exerts the largest effect on the power consumption. Accordingly, if the decompression module 200 according to the present invention is installed at the exhaust side of the vacuum pump 130, the power consumption which might be required for the idling operation can be reduced by at least 50%.

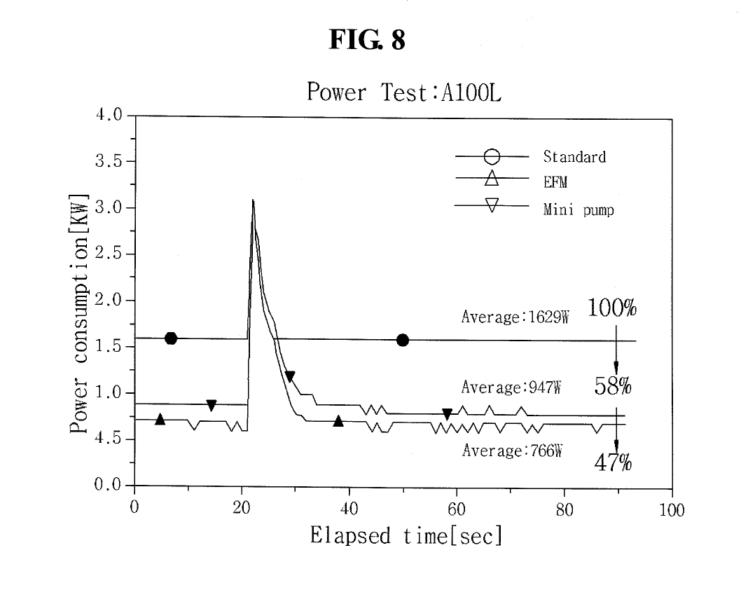

FIG. 8 is a graph illustrating relative decrements in power consumption of the vacuum pump when the decompression module according to the present invention is mounted.

As illustrated in the figure, assuming that the power consumption is considered as 100% when the decompression module 200 according to the present invention is not installed, it is shown that, if the decompression module 200 according to the present invention is installed, the power consumption is reduced to 47%, so that the power consumption can be saved by about 53%.

Even if the above result is simply compared in view of reducing the power consumption, the power consumption can be saved by as many as 11% according to the present invention as compared with the conventional assistant pump with which the power consumption may be simply saved by about 42%.

Further, since the decompression module 200 itself according to the present invention spends no additional power, more electric energy can be totally saved considering the power which might be spent for the assistant pump itself.

However, it is noted that such a result was based on the experiment performed under the conditions of a volume of the load-lock chamber 120 of 71 liters, the vacuum pump 130 of Model EPX180NE, the power consumption during the idling operation of the vacuum pump 130 of 1.7 kW, a lowest pressure of the vacuum pump 130 of 7.5×10⁻⁵ Torr, and a gas supply pressure in the decompression module 200 of 5 Kg_{f}/cm².

According to the decompression module using a gas stream and the vacuum apparatus for manufacturing a semiconductor device, the gas stream using a venturi effect allows the exhaust-side pressure of the vacuum pump to be decompressed without requiring additional power, thereby being capable of reducing the power consumption by at least 50% during the idling operation of the vacuum pump.

Further, the load of the vacuum pump may be reduced during the idling operation of the vacuum pump which might have occupied at least the half of the total operation time of the vacuum pump, so that the lifetime of the vacuum pump can be prolonged.

In addition, the decompression module of the present invention may be very simply installed by the flange-coupling with the exhaust pipe of the vacuum pump, which causes the decompression module to promptly operate.

Although the preferred embodiments of the present invention have been described, the present invention may use various changes, modifications and equivalents. It will be apparent that the present invention may be equivalently applied by appropriately modifying the aforementioned embodiments. Accordingly, the above descriptions do not limit the scope of the present invention defined by the appended claims.

What is claimed is:

1. A decompression module using a gas stream, comprising:
a first branch pipe connected in series to an exhaust side of a vacuum pump connected to a load-lock chamber for manufacturing a semiconductor device;
a check valve installed to the first branch pipe to allow a gas stream exhausted from the vacuum pump only to the atmosphere side;
a second branch pipe branched from the first branch pipe to bypass the check valve; and
a vacuum generator installed to the second branch pipe, the vacuum generator receiving a carrier gas from the outside and allowing the carrier gas to flow to the atmosphere side, thereby resulting in a decompression atmosphere which allows an exhaust-side pressure of the vacuum pump to be decompressed.

2. The decompression module according to claim 1, wherein the vacuum generator includes an inflow end connected to a carrier gas supply pipe for supplying the carrier gas to receive the carrier gas therethrough; an outflow end connected to an atmosphere-side pipe of the second branch pipe to exhaust the received carrier gas therethrough, the inflow end and the outflow end being formed in a straight section; a branch end branched from an intermediate point between the inflow and outflow ends and connected to an exhaust-side pipe of the second branch pipe, the branch end forming the decompression atmosphere by the flow rate of the carrier gas flowing from the inflow end to the outflow end.

3. The decompression module according to claim 2, wherein the intermediate point between the inflow end and the outflow end of the vacuum generator has a smaller internal cross sectional area than those of the inflow end and the outflow end to increase the flow rate of the carrier gas.

4. A vacuum apparatus for manufacturing a semiconductor device, comprising:
a vacuum pump connected to a load-lock chamber for manufacturing a semiconductor device;
a check valve connected in series to the vacuum pump to allow a gas stream exhausted from the vacuum pump only to the atmosphere side; and
a vacuum generator connected in series to the vacuum pump and in parallel to the check valve,
wherein the vacuum generator includes:
an inflow end connected to a carrier gas supply pipe for supplying a carrier gas from the outside to receive the carrier gas therethrough;
an outflow end for exhausting the received carrier gas therethrough, the inflow end and the outflow end being formed in a straight section;
a branch end branched from an intermediate point between the inflow and outflow ends and connected to an exhaust side of the vacuum pump.

5. The vacuum apparatus according to claim 4, wherein the intermediate point between the inflow end and the outflow end of the vacuum generator has a smaller internal cross sectional area than those of the inflow end and the outflow end so as to increase the flow rate of the carrier gas.
